(19) United States
(12) Patent Application Publication
(10) Pub. No.: US 2008/0065758 A1
(43) Pub. Date: Mar. 13, 2008

(54) Dynamic transient buddy and contact lists

(75) Inventor: Chandrasekhar Narayanaswami, Wilton, CT (US)

Correspondence Address: MICHAEL BUCHENHORNER, P.A., 8540 SW 83 STREET, SUITE 100, MIAMI, FL, 33143, US

(73) Assignee: International Business Machines Corporation, Armonk, NY (US)

(21) Appl. No.: 11/519,594

(22) Filed: Sep. 12, 2006

(51) Int. Cl. G06F 15/16; G06F 15/173

(52) U.S. Cl. 709/224; 709/206; 709/223

(57) ABSTRACT

A computer implemented method for creating and displaying a transient buddy list includes the steps of: browsing through groupings of items associated with an interval of time and referencing a person or persons; searching for at least one match to a person or persons referenced in an item grouping by accessing information stored in a repository; mapping the person or persons referenced in the item grouping to the person or persons referenced in the stored information within the repository for accessing an at least one instant message identifier of the person or persons; creating the buddy list, populated by the identifiers derived from the mapping; sorting the buddy list according to time intervals; and displaying the buddy list. Additionally, an interface for creating and displaying a transient buddy list includes: a time interval digital display mechanism; at least one of: a time selection tool, a date selection tool, and a timeline selection tool for selecting a range between two dates; and a display screen for displaying the buddy list.

### CROSS-REFERENCE TO RELATED APPLICATIONS

Not applicable.

### STATEMENT REGARDING FEDERALLY SPONSORED-RESEARCH OR DEVELOPMENT

Not applicable.

### INCORPORATION BY REFERENCE OF MATERIAL SUBMITTED ON A COMPACT DISC

Not Applicable.

### FIELD OF THE INVENTION

The invention disclosed broadly relates to the field of creating contact lists for communication and more particularly to buddy lists in instant messaging and phone lists (address books) in cellular phones.

### BACKGROUND OF THE INVENTION

Instant messaging, “IM” or “IMing,” is the real-time exchange of text messages through a software application. Instant messaging differs from ordinary e-mail in the immediacy of the message exchange and also in that it makes a continued exchange simpler than sending e-mail back and forth. Typically, a user logs into an IM system and announces his presence to others in the IM community. A central entity keeps track of all users who are online at any given time. For an IM to function, both parties to a communication must be online at the same time and the intended recipient must be willing to accept instant messages. An attempt to send an IM to someone who is not online, or who is not willing to accept IMs, will result in notification that the transmission cannot be completed. If the online software is set to accept IMs, it alerts the recipient with a distinctive sound, a window that indicates that an IM has arrived and allows the recipient to accept or reject it, or a window containing the incoming message.

The parties to an IM communication are referred to as “buddies” and communicants build what is known as a “buddy list”—a list of people with whom they wish to communicate. The process of adding a person to your buddy list typically involves sending a request to the other person, perhaps by e-mail, to grant permission to be added as your buddy. Similarly, anyone who wants you on their buddy list has to obtain your permission first. Once the other person grants such permission, the person can be added to your buddy list. When any of your buddies are online, you can initiate a private chat through IM with that buddy. You know which of your buddies are online by an indicator next to that buddy's screen name on your buddy list. When you launch your IM software, it connects with the service's IM server and logs you on. The server checks your buddy list to see if any of your contacts are also logged on. Your list updates to show who is currently online. At the same time, your contacts' lists update to indicate that you're online.

In addition to keeping track of who is offline and who is online, a buddy list can also be used to see who is online but away from their computer, who has their phone turned off, who has their phone turned on, or who is currently talking on their phone. Additional buddy information such as his contact information can be shown by hovering the cursor over the buddy or by right clicking on the buddy on IM systems, for example, IBM NotesBuddy, and Lotus Sametime 7.5. Other information could also include when the buddy was last active, what activity they are currently engaged in, their current location, etc.

To initiate communication with a buddy who is currently online and accepting IM messages, you generally click on that buddy's screen name (or representative icon). An IM window will appear displaying a text box where you type your message to your buddy. After you type your note and click on the Send, or transmit, button, the message travels directly to your buddy. In some cases the message may be routed to the IM server, then immediately forwarded to your buddy's computer. Your buddy will receive notification that a message has been sent. This entire transaction appears to occur instantly. With some instant messaging applications, it's possible to store a message on the instant messaging server temporarily if a buddy is unavailable, so that when the buddy does become available, the message will be sent.

IBM Lotus Sametime 7.5 looks at a calendar entry and brings up a window with the messaging contacts (buddies) for that calendar entry. However, this list is made available only a few minutes before the meeting starts and it is not possible to scroll through a timeline from an IM application to find your buddies. Often you may want to contact a person you may be meeting several hours later and discuss something with this person, for example to discuss the strategy for the meeting, obtain documents related to the meeting, ask if another person can join the meeting, etc. Lotus Notes 7.0 also allows you to open a calendar entry in a detailed view and chat with all participants or the chair of the event. However, this also requires additional steps of manually finding an event from a calendar and then opening the event and then accessing the chair or the participants of the event. There is no provision to further select with whom you wish to communicate, perhaps a particular member attending the event.

There is a need for an IM application which displays time-synchronized buddy lists which can be dynamically viewed and updated in order to facilitate quick access to people with whom a user is likely to communicate on any given day.

### SUMMARY OF THE INVENTION

Briefly, according to an embodiment of the invention, a computer implemented method for creating and displaying a transient buddy list, including indicators of the current status of each element in the buddy list, includes the steps of: browsing through groupings of items associated with an interval of time and referencing a person or persons; searching for at least one match to a person or persons referenced in an item grouping by accessing information stored in a repository; mapping the person or persons referenced in the item grouping to the person or persons referenced in the stored information within the repository for accessing an at least one instant message identifier of the person or persons; creating the buddy list, populated by the identifiers derived from the mapping; sorting the buddy list according to time intervals; and displaying the buddy list.

According to another embodiment of the invention, a system includes a processor configured with logic for performing the above method steps. Additionally, an interface for creating and displaying a transient buddy list includes: a time interval digital display mechanism; at least one of: a time selection tool, a date selection tool, and a timeline selection tool for selecting a range between two date; and a display screen for displaying buddy lists.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 shows an example of calendar entries in an electronic calendaring system, according to the known art.

FIG. 2 shows three buddy lists created from the calendar entries of FIG. 1, according to an embodiment of the invention.

FIG. 3 is a simplified flow diagram of the process involved in creating a dynamic time-synchronized buddy list according to an embodiment of the invention.

FIG. 4 is an illustration of a clock view console according to an embodiment of the invention.

FIG. 5A is an illustration of a clock face with sun and moon graphics designating AM and PM, according to an embodiment of the invention.

FIG. 5B is an illustration of a clock face with an annular band bisected around the clock face, according to an embodiment of the invention.

FIG. 6 is an illustration of the clock view console of FIG. 4 with an exploded calendar view, according to an embodiment of the invention.

FIG. 7 is an illustration of the buddy list display as selected from the calendar view of FIG. 6, according to an embodiment of the invention.

FIGS. 8A and 8B are illustrations of two views of a clock view console in a smaller form factor, according to an embodiment of the invention.

FIG. 9 is an illustration of a clock view with icons indicating buddy lists, according to an embodiment of the invention.

FIG. 10 is an illustration of a clock view with light-emitting diodes indicating buddy lists, according to an embodiment of the invention.

FIG. 11 is a high level block diagram showing an information processing system according to an embodiment of the invention.

### DETAILED DESCRIPTION

We describe a method to automatically create short-lived buddy lists synchronized with a user's calendar and events instead of requiring the user to add or look up buddies manually. Configuring groups of buddy lists dynamically and proactively will help IM users significantly in their communications. Scrolling through a timeline will display buddy lists created for a specific time period. There will be no need to go through the steps of locating a calendar entry, clicking on that calendar entry to call it up, locating a contact person listed in that calendar entry, determining the person's IM identifier and then clicking on that person's IM icon to initiate a chat. The IM identifier is often the screen name, but it could also be the actual name of the person or a user-supplied nickname.

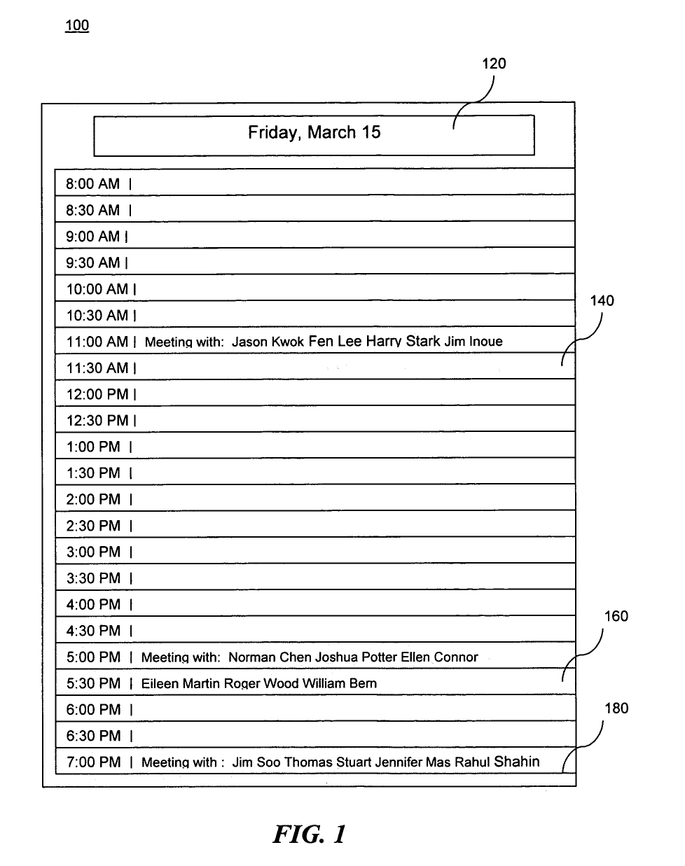

Referring to FIG. 1 there is shown an example of a one-day calendar view 100 common to many electronic calendaring systems. In this view 100 the date 120 is displayed, along with time intervals broken down in half-hour time increments. Appointments for the day appear in the calendar, displayed next to the corresponding time interval. For example, the calendar of FIG. 1 shows that the user has a meeting with four individuals (Jim Inoue, Jason Kwok, Fen Lee, and Harry Stark) starting at 11:00 a.m. As shown in this example, and common to many electronic calendaring systems, a time interval containing an appointment is shown in a different color or tone than an “empty” time interval. In FIG. 1 the time interval from 11:00 A.M. to 12:00 noon is shown shaded in grey to designate that it contains a scheduled event. This shaded time interval 140 also displays the contacts associated with that scheduled event. The contact names are shown underlined in this example, to designate that they may be linked to their contact information contained in the calendaring function, as can be done with some calendaring tools, such as IBM Lotus Sametime 7.5. The names may be added by a user directly into the calendar page or by entering the information in a pop-up window. Currently, a user of the calendar 100 may wish to contact Jim Inoue prior to their 11:00 meeting. He would double-click on Mr. Inoue's name in the calendar view 100 if this feature is available in whatever proprietary calendar system he uses, or he would go to his “Contacts” list and search for Mr. Inoue. Once he finds Mr. Inoue's name, he can determine his IM screen name and find that screen name on his IM buddy list. Note that IM screen names are chosen by their users and most IM systems give users great flexibility in creating screen names. Many IM screen names do not bear any resemblance to a user's actual name.

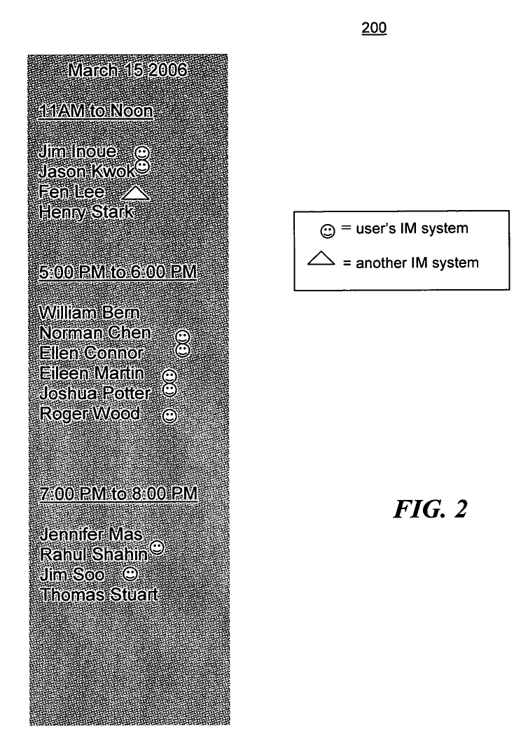

The present invention greatly improves upon this method by automatically generating a temporary buddy list for each day at the beginning of each day (at or close to 12:01 a.m.). According to an embodiment of the present invention, assuming the current date is March 15^{th}, a buddy list for March 15^{th} was automatically generated with the contacts associated with the three scheduled events of that day as shown in the calendar view of FIG. 1. FIG. 2 shows this March 15^{th} buddy list 200. The buddy list 200 contains all of the people with whom the user is scheduled to meet with, speak with, or submit a task for on this day. Referring to the calendar entries of FIG. 1 the auto-generated March 15 buddy list 200 includes: Jason Kwok, Fen Lee, Harry Stark, Jim Inoue, Norman Chen, Joshua Potter, Ellen Connor, Eileen Martin, Roger Wood, Jim Soo, Thomas Stuart, Jennifer Mas, William Bern and Rahul Shahin. Note that the buddy list 200 has been automatically sorted by time interval and also sorted alphabetically within time interval. Another advantageous feature of this buddy list 200 is that the contact names are shown with buddy icons (smiley faces in this example) if the contacts have an instant message screen name. If the contact does not subscribe to any IM system, the contact name shows no icon. In the buddy list 200 of FIG. 2 Henry Stark, William Bern, Jennifer Mas, and Thomas Stuart do not subscribe to an IM service therefore there is no icon next to their names. Another feature of this system is that the buddy list 200 can display the actual names of the contacts, not their screen names. In this way a user knows exactly who is listed.

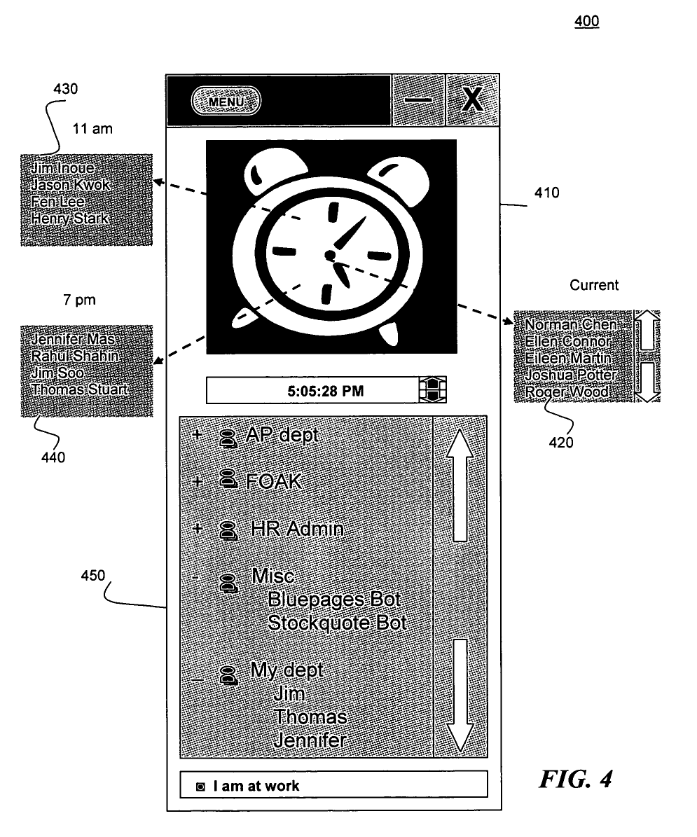

There are several different IM systems in widespread use today; therefore, in order to alert a user that a particular contact belongs to an IM system different from that of the user's system, a distinct icon is shown next to that contact's name. Referring to FIG. 2 the contact by the name of “Fen Lee” is shown with a distinct icon to reflect the fact that Mr. Lee subscribes to another IM system. According to the present invention, the buddy list 200 is incorporated into the clock view as shown in FIG. 4 to be discussed later.

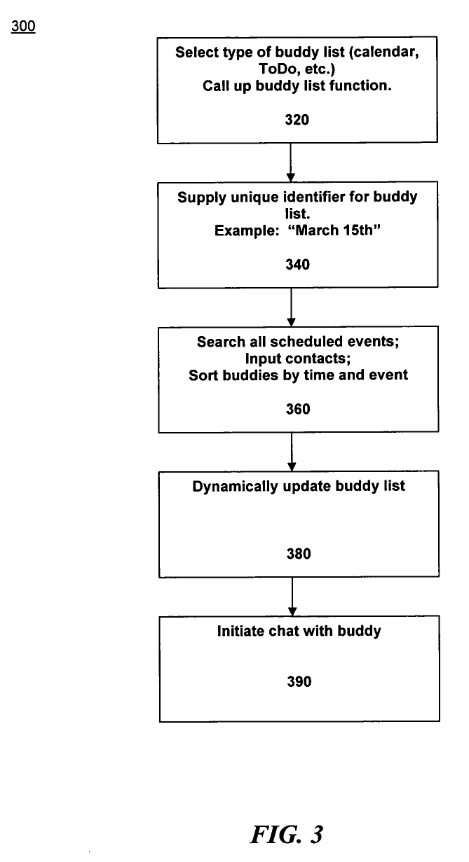

Referring to FIG. 3 there is shown a flowchart 300 for creating buddy lists for future dates. Assume a user wants to create a buddy list for March 18^{th} and today is March 15th. This buddy group for the March 18th contacts will be given the name “March 18^{th}.” The buddy list will contain all of the people with whom the user is scheduled to meet with, speak with, or submit a task for on that day. The buddy group creation begins at step 320 when the user prompts the IM application to launch a process to build a list and goes through the user's calendar and other scheduled events for that date for creating a buddy list. This will not require a change in a proprietary calendaring system because electronic calendaring systems allow programmatic access to events on a specified date and time. The buddy list creation method would supply a unique identifier (mostly for internal use) for that buddy list in step 340. This unique identifier is preferably a descriptive name by which that particular buddy list will be known for use when the user wants to save temporary buddy lists or to reduce clutter on his screen. In this example the name provided is “March 18^{th}.” Another example name could be “March All Hands Meeting.” The user would not need to manually add buddies to “March 18th” because the buddy list creation function will automatically search through the electronic calendar entries for March 18th and move all listed contacts to the “March 18th” buddy list. Everyone listed in the calendar for that date with an associated buddy screen name is added to the list, with a buddy icon. Anyone who is on the list but does not subscribe to an IM group will be displayed with his/her name, but with no associated buddy icon.

Using a calendar function which provides a link to a contact list is not the only way the buddy list creation method can access the contacts for populating the buddy list. This is important because not all calendaring systems provide for accessing contacts from a calendar view. The buddy list function can search through any documentation on the user's system where contacts are listed or information on other devices owned by the user or even information stored on web repositories. The function could mine an electronic corporate directory, virtual business card lists, upcoming common events in the user's place of work, or town or region, or national events that the user is interested in, etc. searching for a match to a name listed in the user's calendar. If desired and also permitted, events listed in other devices or systems owned by the user's family, friends or colleagues can also be searched. The user can specify the repositories to be searched. Once a match is found, it is placed in the buddy list. Examples could include the host, coordinator, or organizer for an event and their backups and administrative assistants. A tag explaining why a name was added to the buddy list is also added. For example, there is a little league baseball game today and the coach is added to today's buddy list, therefore a tag would be attached to his name. The tag could either be displayed in the IM application or could be hidden and shown when the user places the cursor over the name. The entire process described above happens in the background, without any user invention. In the event the user does not input a name for the buddy list, the buddy list function would simply generate an internal logical identifier to associate with the buddy list for the time period the user is interested in. This logical identifier could be the date from a calendar entry, a time interval, etc.

For the “March 18th” list, the function proceeds in step 360 by browsing through all calendar entries for the day including telecoms, e-meetings, to do lists, etc. Each person or group associated with a calendar entry would be automatically included in the “March 18th” buddy list. This group is sorted alphabetically within time interval. Sorting by time interval is an important feature so that the buddy list can sync with a clock as will be shown in FIG. 4. All participants for an 11-11:30 telephone conference as set in a user's calendar are added to the user's buddy list under the 11-12 section for that day. As another example, all interviewers for a candidate you are hosting could be added to your buddy list for the days the candidate is being interviewed.

The act of accepting or creating a calendar event could automatically populate the entry in the buddy list in step 380. Conversely, deleting a calendar entry could remove the items from the buddy list. We assume a buddy list has been created for today, March 15^{th}. Later on in the day you receive an invitation to attend a telephone conference and you accept. Your acceptance as an attendee of this telephone conference will prompt the function to automatically insert all other telephone conference attendees and the conference chair into your buddy list. The function would of course check for duplicate entries and remove any duplicates.

Likewise, if the buddy list for today includes all of the telephone conference participants listed for an event today and then later on you decline attendance, the function will automatically remove the telephone conference attendees from the buddy list. Note that any buddies from the telephone conference list which are also part of another event for today will remain on that list. For example, if “John Doe” was on your list as a telephone conference attendee and he is also on the March 15^{th} list because you are meeting with him later on, he will not be removed from the buddy list.

This technique applies not only for today's calendar entries but for past and future entries. The user can then interact with people related to an upcoming event, for example for preparation of refining a meeting agenda, etc. Additionally, a user may want to contact someone about a meeting which occurred in the past. This goes beyond what IBM Lotus Sametime provides by allowing users to chat with a sender or chat with all recipients of an email or calendar event. This system is also more intuitive to use since the temporary buddy lists are accessible from the IM application instead of a calendar application and fewer clicks are required to initiate communication. Current software technologies such as Ajax and Web 2.0 technologies can be used to implement the computation of the buddy lists proactively as the user is scrolling through the timeline and for the presentation of buddy lists and fetching additional information asynchronously based on cursor location and movements on the user's screen.

Next, after the buddy list has been created, in step 390 the user initiates a chat with one of the buddies on the March 15^{th} buddy list. This is accomplished by simply scrolling through the timeline view of the buddy list as shown in FIG. 4.

Referring to FIG. 4, there is shown an illustration of a clock view console 400 for buddy lists according to an embodiment of the invention. The top portion of the console 400 shows a stylized clock face 410. The clock face 410 shows the current time of 05:05:28 PM. The bottom portion 450 shows a drop-down list of buddy groups.

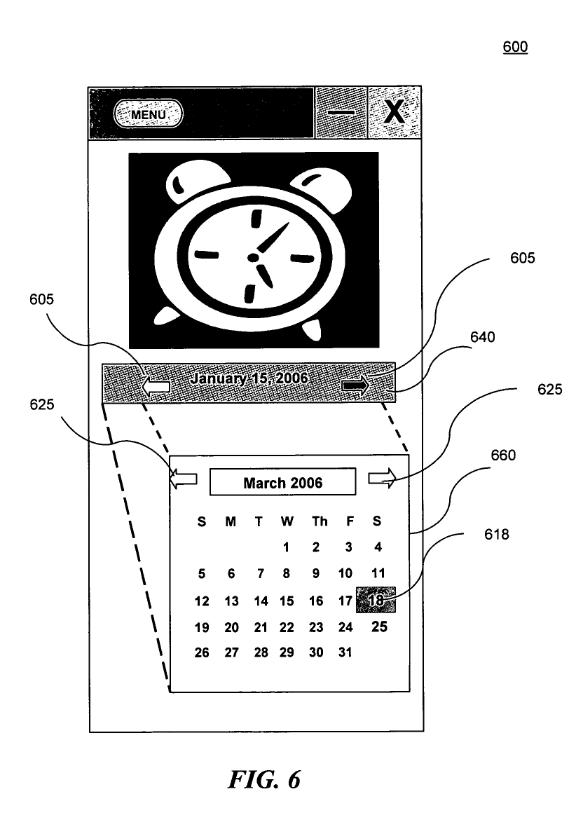

The preferred embodiment of the buddy list creation tool is to select a date and time in the clock portion 410 of FIG. 4. This way there is no need to open a calendar application at all. The user may also select a portion of a future date, e.g., 8 A.M.-11 A.M. of March 18^{th} as will be discussed with respect to FIG. 6. A user would be shown a window similar to that displayed on an airline website with date and time range selection tools.

Organizing buddy lists around a clock face is an important feature to tie a particular buddy group to an event in time. Moving a cursor or stylus over the clock face 410 displays pop-up blocks (420, 430, 440) of the various buddy lists associated with the designated time period. Moving a cursor or stylus over the center region of the clock face 410 pops up the buddy list 420 for the current time period if there is an entry associated with the current time period. Note that time periods can be grouped in hour, half-hour, 2-hour intervals, or as a user specifies. Let's say the user has selected one-hour intervals for time periods and the current time of 5:05 P.M. falls in the 5:00 P.M. to 6:00 P.M. time period and there is an entry for that time period with an associated contact person or group. Moving a cursor or stylus over the central region of the clock face 410 will call up the buddy list 420 associated with the current time period of 5:00 P.M. to 6:00 P.M.

The same buddy list 420 could also be displayed by moving a cursor (or stylus if using a personal digital assistant) anywhere over the 5:00 to 6:00 P.M. time range on the clock face 410. As a user scrolls through the timeline and reaches the time for a scheduled event, the buddy list for that event will pop up. If there are overlapping or conflicting events, a union of buddies for all events will be shown. In some cases the user may choose to consider only confirmed appointments and not ones “penciled in” or tentative. Now all that a user has to do is click on the contact's name on that buddy list. This will immediately open a dialog box for a conversation with that buddy. The dialog box will be the same proprietary dialog box as provided by the IM service providers. A conversation with a buddy will proceed through the protocol as provided by the user's particular IM service provider. Note that this buddy list function works with several major IM service providers.

The timeline example is just one of the many uses for a dynamic transient buddy list. For example, a ToDo item list corresponding to a purchase order would add the list of authorized buyers/agents to the buddy list. A Human Resources related ToDo list would add the Human Resources personnel to your buddy list. In the example shown in FIG. 4 moving a cursor over the 11:00 hour of the clock displays a small window with the buddy list 430 for the 11:00-noon time period. Moving a cursor over the 7:00 P.M. to 8:00 P.M. time period on the clock face 410 will display the buddy list 440 associated with that time period. Note that each buddy list view can comprise a scrolling feature if necessary to display a high volume of buddies, as in buddy list 420. Within each time slot the buddies will be sorted alphabetically for convenience. Say there are two appointments, 11-11:15 and 11:15-11:30 A.M. By hovering at 11 o'clock, the buddies for the 11-11:15 and 11:15-11:30 appointments and any buddies for the 11:30-noon appointment will be shown, assuming a one-hour interval setting.

If a user prefers a half-hour interval setting or any other interval setting, that is an available option that the user can select. Assuming a half-hour interval setting, hovering a cursor over 11 o'clock will display the buddies for only the 11:00-11:15 and 11:15-11:30 appointments. The buddies for the 11:30-noon appointment will not be shown until and if the user hovers around 11:30 o'clock.

If the number of temporary buddies for the day is small, the system can just show the list for the whole day when the user positions the cursor in the center of the clock instead of just for the current hour.

Hovering the cursor over a buddy's name can pop up additional information and present several options for initiating actions. One option is to initiate a chat with the person. Examples of additional information include the person's phone number and address information and the reason why that person was added to the temporary buddy list.

Referring again to the console 400 of FIG. 4, moving the cursor over another point of the clock face 410 will bring up a buddy list associated with that time period, if there is one. Distinguishing between A.M. and P.M. time is important and this can be done in several ways. The importance of distinguishing between A.M. and P.M. is highlighted with the example of a buddy list associated with a 7:00 P.M. meeting. Moving the cursor or stylus over the numeral “7” on the clock face 410 may bring up a buddy list associated with an event scheduled for a 7:00 A.M. event, rather than the 7:00 P.M. meeting. This problem is overcome by splitting the twenty-four hours of a day into two time intervals. One method is to allow a user the ability to switch between two different settings. A user could, for example, set a default setting of 8:00 A.M. to 7:00 P.M. on the clock so that the clock settings will stay in that timeline until the user switches to a 7:01 P.M. to 7:59 A.M. setting. This method may be more intuitive for users who normally schedule meetings only between 8:00 A.M. to 7:00 P.M. With the default setting, pointing to the numeral “7” on the clock face will always refer to 7:00 P.M. The clock face 410, however, will continue to show the actual time of day, regardless of whether it is in the active setting.

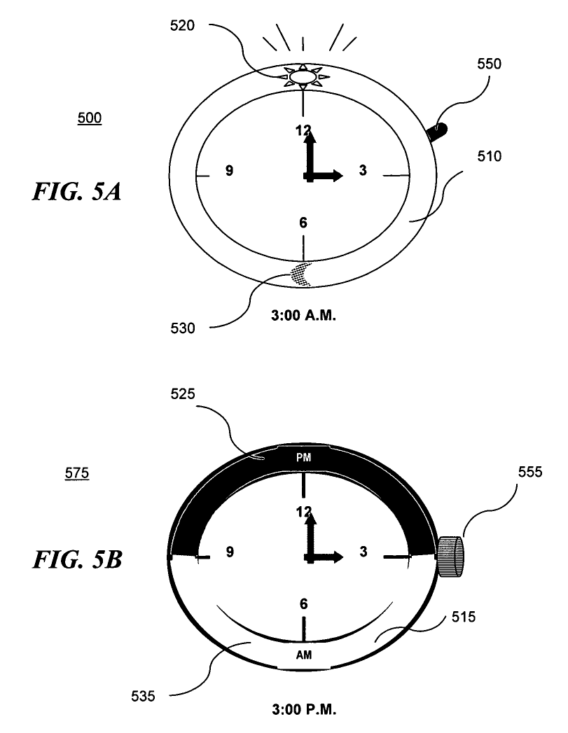

Now that a user can switch from one timeline setting to another, how does a user know which setting is active? According to an embodiment of the present invention, there are a few different ways that a user will know what setting is currently active. Referring to FIG. 5A there is shown a clock face 500. The main portion of the clock face 500 is surrounded by an annular band 510. A small knob 550 is located on the outside of the annular band 510 for setting the timeline. Depressing the knob 550 allows a user to toggle back and forth between A.M. and P.M. settings. The A.M. and P.M. settings could be the standard settings, i.e., one minute after midnight until one minute before noon is A.M. and noon to midnight is P.M. Alternatively, the user could override the standard AM/PM configuration and designate settings more intuitive for workday use. For example, a user may want to designate the hours between 8:00 o'clock in the morning and 8:00 o'clock in the evening as daytime (shown as A.M.) and designate 8:01 P.M. until 7:59 A.M. as after-hours (PM).

Modifications to the annular band 510 could be made to clearly show the current setting of the clock face 500. Referring again to FIG. 5A we see one example of a modification made to the annular band 510. For this example, assume a standard timeline setting with a default setting of A.M. time (12:01 a.m. to 11:59 a.m.). The clock face 500 shows a current time of 3:00 o'clock. The annular band 510 shows two icons: a sun icon 520 in the upper half of the band 510 and a moon icon 530 in the lower half of the band 510. The sun icon 520 is shown lit up to indicate that the watch is currently set to an A.M. setting. The moon icon 530 is shown dimmed to indicate that the P.M. setting is “off.” Depressing the knob 550 at this point will switch the watch to a P.M. setting; therefore the sun icon 520 will dim and the moon icon 530 will be illuminated.

FIG. 5B illustrates another embodiment showing a clock face 575 with an annular band 515 surrounding the time mechanism of the clock face 575. The annular band 515 is bisected with a top portion 525 and a bottom portion 535. The top portion 525 in this example is designated as the P.M. indicator and the bottom portion 535 is designated as the A.M. indicator. This is the reverse of FIG. 5A. A button 555 performs the same function as the knob 550 of FIG. 5A; i.e., it allows a user to switch timeline settings by scrolling the button backwards or forwards. FIG. 5B shows the clock face 575 in the P.M. setting, as indicated by the shading or highlighting of the top portion 525. The A.M. setting is shown dimmed. It should be understood that the illustrations of FIG. 5A and FIG. 5B are meant to provide examples of the variety of embodiments for indicating timelines on clock faces and should not be taken as limitations to the embodiments.

In addition to what has been shown in FIGS. 5A and 5B, timelines can be distinguished by showing the clock face in different colors to represent different timelines. For example, a white clock face could designate an A.M. setting while a grey clock face could designate a P.M. setting. Those with knowledge in the art will understand that the foregoing examples are meant to provide examples, not to limit the scope of the embodiments of the present invention.

Creating a buddy list by selecting a date in the future is easily done as shown in the illustration of FIG. 6. FIG. 6 shows the clock view console 600 of FIG. 4 with some modifications. A calendar bar 640 appears in the console 600 and by default it is set to the current date (Jan. 15, 2006 in this example). Selecting the calendar bar 640 will display the current month's calendar. Selecting may be accomplished by mouse-clicking on the calendar bar 640 or by touching it with a stylus.

Additionally, the calendar bar 640 has forward and backward arrows 605 so that a user can select previous and/or future dates in time. In the example of FIG. 6 the forward arrow has been selected (by clicking on the arrow 605) and the user has scrolled through the months (using the month view arrows 625) until the calendar view 660 for the month of March appears. The user has selected March 18^{th} by depressing the numeral “18” on the calendar view and this highlights the selected date 618.

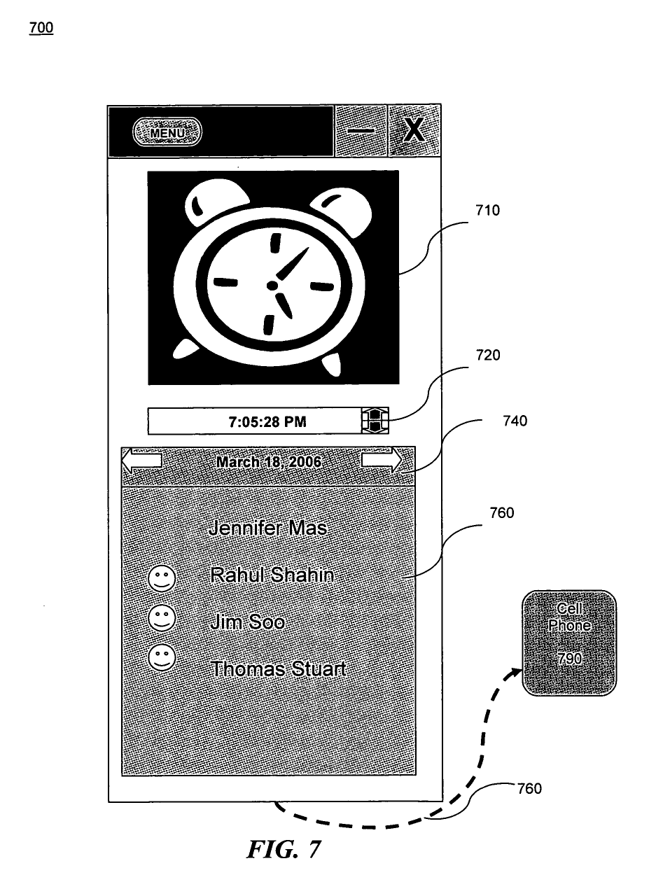

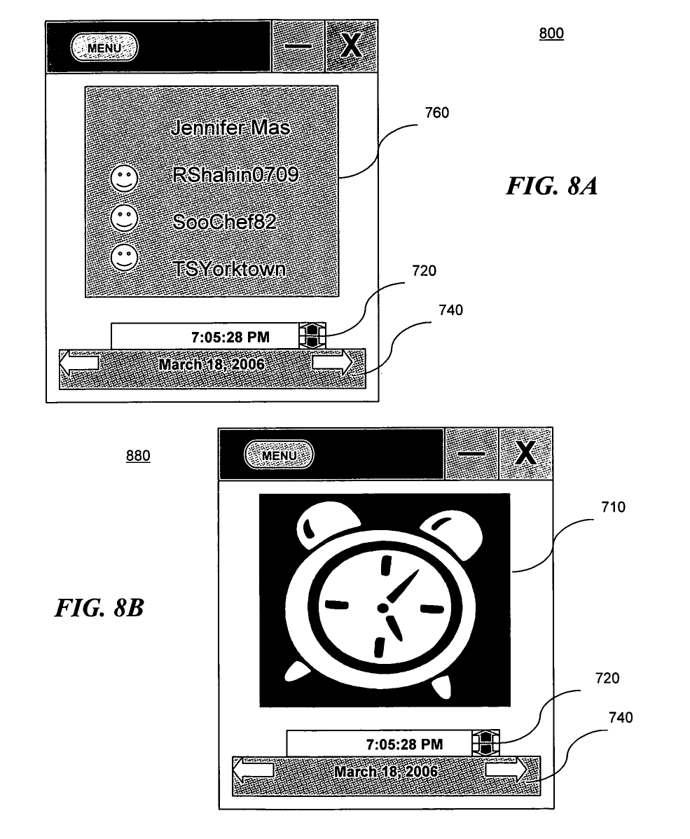

FIG. 7 shows the clock view console 700 of FIG. 6 with a clock face 710, a time selector bar 720, and a date selector bar 740. Also shown is the buddy list of the selected date and time (Mar. 18, 2006 7:00 to 8:00 P.M.) from FIG. 6. The buddy list 760 is displayed over the directory 460 of FIG. 4. FIG. 7 also illustrates another significant feature of the present invention. Currently, the popularity and utility of Instant Messaging has broadened its reach to include IM through cell phones and PDAs. The transient buddy can be synchronized with a user's mobile device such as a cell phone 790. Doing this will enable the user to have access to a dynamic buddy list on his PDA or cell phone. The smaller form factors of FIGS. 8A and 8B lend themselves to the small sizes of cell phone display screens. In some cases the IM application used by the user on the PC may not be supported on the user's cell phone. In this case though the IM application is not available, the phone numbers of all contacts for the day or hour will be readily available.

Other information such as the addresses for the contacts for the day can also be sent to the cell phones. An additional feature of the buddy list function is reciprocity. The transmittal of data can flow in reverse, meaning that the cell phone 790 can transmit contact information to the IM application. Cell phones contain identifiers (actual names or nicknames) and contact information (phone numbers, email addresses, screen names) that can easily be transmitted to an IM application. The cell phone 790 could be programmed to automatically generate a transmittal to an IM application with the identifiers and contact information for all calls made during the course of a day. This data will be used by the IM application to populate the buddy list 760. Clearly someone with knowledge in the art will understand that these are but a few examples of embodiments of the present invention and should be not be construed as limitations.

This buddy list 760 can be accessed through a clock interface as described earlier. The user thus has quick access to many of the telephone numbers he may require for the day rather than having to call directory assistance or an administrative assistant or search the web for this information. In other instances the mobile device may not provide as rich an interface as a PC. In such cases the list may just be presented under a “Today” menu entry.

The tool for carrying out the sync operation may be a USB wire 760 as shown by the dashed line of FIG. 7, or via a wireless connection, such as Bluetooth Wireless.

Referring to FIG. 8A there is shown an alternative embodiment where a smaller form factor 800, such as a wrist-worn device, is used to display the buddy list 760 of FIG. 7. In this form factor 800 the buddy list is temporarily displayed over the clock face 710. In essence it shares space with the clock face in order to facilitate a smaller form factor. The example of FIG. 8A shows a buddy list displaying IM screen names, rather than actual names. In this display 760 one of the buddies, Jennifer Mas, does not subscribe to an IM service, therefore she has no screen name and her actual name is shown. Quite often, IM buddy lists are shown with screen names representing the buddies, but the actual names of the buddies or even user-selected nicknames can be displayed instead. Many IM systems such as IBM NotesBuddy allow users to select which nomenclature they prefer.

FIG. 8B illustrates a different view 880 of the same form factor 800. In FIG. 8B, the buddy list has faded and the original clock face 710 has reappeared. This sharing of space can be accomplished in different ways. One example is to dim the clock face 710 into the background whenever a user selects a buddy list, while displaying the buddy list in a brighter view over the clock face. The buddy list could be shown for a pre-selected period of time and then it would dim into the background, and then the clock face 710 would re-illuminate.

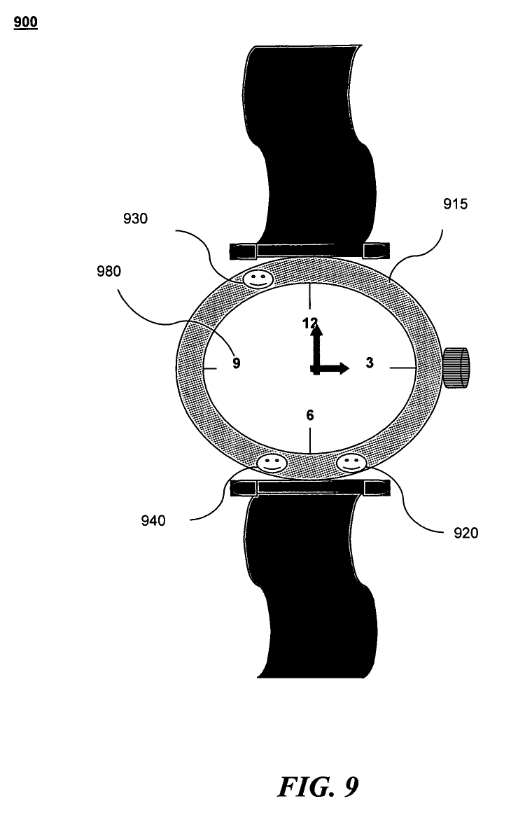

According to another embodiment of the invention, the annular band 515 as previously described with respect to FIGS. 5A and 5B can also display “flags” indicating the presence of buddy lists associated with time intervals. Referring now to FIG. 9 there is shown a small form factor time mechanism 900, such as the display screen of a cellular phone, or a wrist-worn device, wherein an annular band 915 around the clock face 980 displays three indicators (smiley faces in this example) representing buddy lists. Indicator 920 is shown at the five o'clock position, indicator 930 is shown at the seven o'clock position and indicator 940 is shown at the eleven o'clock position. These three indicators 920, 930, and 940 correspond to the buddy lists as shown in FIG. 2 and clearly and effectively indicate to a user where the buddy lists for that day can be located. Without the flags a user can locate the buddy lists by hovering over the clock face 980 with a stylus (or performing a roll-over with a mouse). The flags 920, 930, and 940, however, enable a user to quickly pinpoint the location of the buddy lists.

Additionally, the flags 920, 930, and 940 serve as a reminder of upcoming events since the flags indicate the presence of buddy lists and buddy lists are tied to scheduled events, according to an embodiment of the invention. Rather than having to check a calendar or call the office, a user can confirm, with a quick glance at the device 900, that appointments are scheduled for that day at eleven o'clock, five o'clock, and seven o'clock. As an example, assume the user of the device 900 is away from the office and runs into a friend who wants to meet up later in the day. With a quick glance at the device 900 the user can let the friend know that he or she has meetings scheduled for eleven o'clock, five o'clock, and seven o'clock, but is otherwise available (based on the flags shown in FIG. 9). Assume also that the friend wants to meet at seven o'clock and wants to know if the user can cancel the meeting scheduled for seven o'clock and reschedule that meeting for another time. The user can then select the buddy list for the seven o'clock meeting and immediately send instant messages to the buddies on the list rescheduling the meeting. The device 900 can easily be a cell phone since cell phones are also timepieces and many people today rely on their cell phones, rather than wristwatches, to tell time.

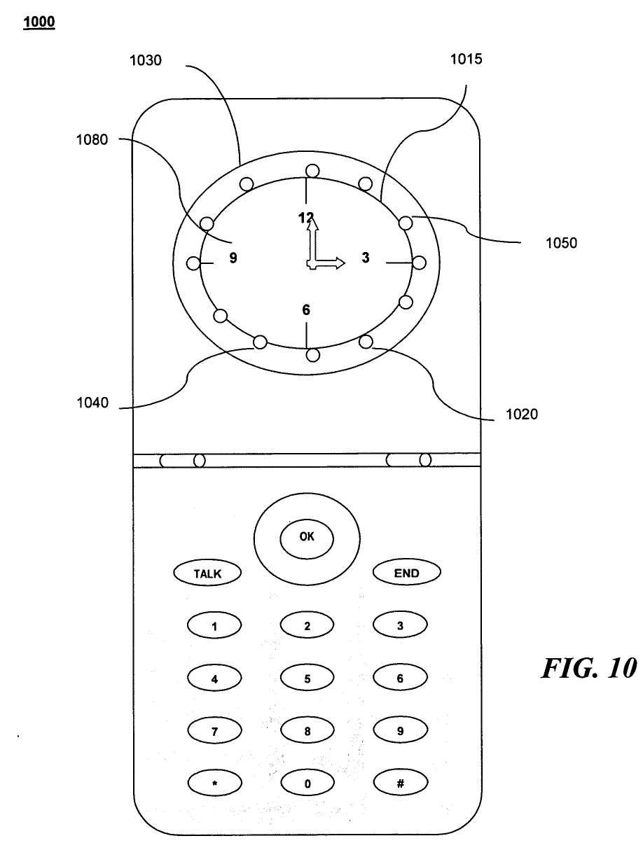

The flags 920, 930, 940 can be any type of visual indicator, such as icons representing buddy lists as shown in FIG. 9, or light-emitting diodes (LED) that are activated when a buddy list is created, as shown in FIG. 10. Other indicators can be employed, provided that the indicators are viewable, yet sized for small form factor devices.

Referring to FIG. 10 there is shown a small form factor time mechanism 1000 with an annular band 1015 around a clock face 1080. The annular band 1015 has twelve small apertures 1050 positioned around the band 1015 and corresponding to the twelve numbers on a clock. Each aperture 1050 houses an LED that is activated whenever a buddy list is added. For example, in FIG. 10, assume three buddy lists have been added corresponding to the five o'clock, seven o'clock, and eleven o'clock times. Therefore, the three apertures 1020, 1030, and 1040 are shown illuminated. This mechanism 1000 could be realized purely as a digital display, such as the display on a cellular phone, or alternatively, it could be a combination of physical elements (the annular band 1015) and a digital display.

Once the end time of a scheduled event has passed, the flags will disappear (or in the case of the LEDs, will turn off). The flag indicators are most useful when dealing with only a few buddy lists at a time. The flags will lose their effectiveness if there are too many of them around the clock face 980 or if there are too many LEDs illuminated around the clock face 1080.

Buddy lists tied to events are transient and typically not meant to be kept indefinitely. A user can specify that a transient buddy list be kept until the event is over, until the end of the business day, or any other specifiable interval. After that the lists are deleted. Alternately, a user may want to retain a buddy list. In that case, the buddy list can be cached and stored in a buddy list history table for later retrieval. The buddy list can be accessed by using the date selection bar 720 of FIGS. 7 and 8 to search for and select the desired date.

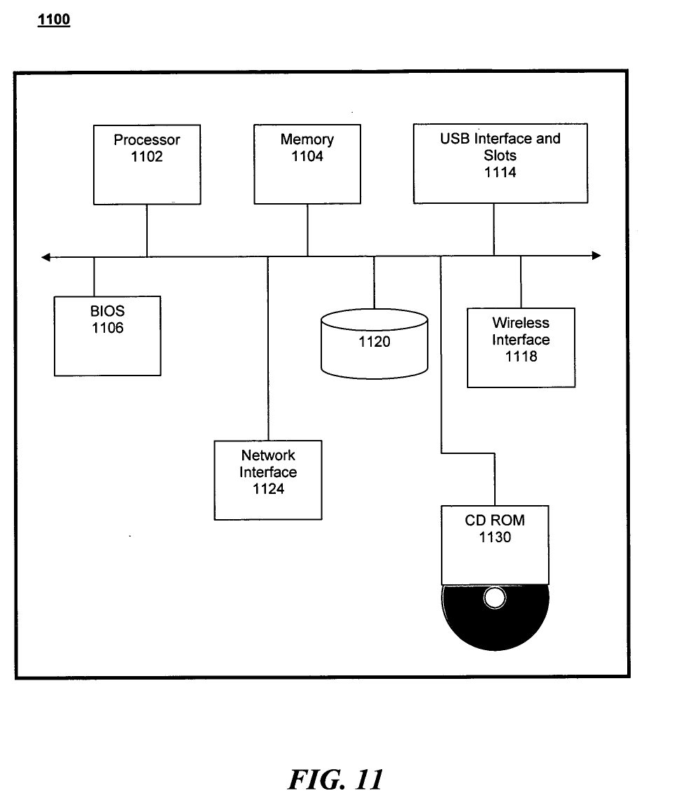

Referring to FIG. 11, there is shown a block diagram of an information handling system 1100 according to another embodiment of the invention. The system 1100 comprises a processor 1102, a memory 1104, and an input/output (I/O) subsystem 1106. The memory 1104 represents either a random-access memory or mass storage. It can be volatile or non-volatile. The system 1100 can also comprise a magnetic media mass storage device 1120 such as a hard disk drive. The I/O subsystem 1106 may comprise various end user interfaces such as a display, a keyboard, and a mouse. The I/O subsystem 1106 may further comprise a connection to a network 1124 such as a local-area network (LAN) or wide-area network (WAN) such as the Internet. A wireless interface 1118 supports a high-speed wireless connection to the Internet.

According to another embodiment of the invention, a computer readable medium, such as a CDROM 1130 can include program instructions for operating the programmable computer 1100 according to the invention. What has been shown and discussed is a highly-simplified depiction of a programmable computer apparatus. Those skilled in the art will appreciate that other low-level components and connections are required in any practical application of a computer apparatus.

Therefore, while there have been described what are presently considered to be the preferred embodiments, it will be understood by those skilled in the art that other modifications can be made within the spirit of the invention.

We claim:

1. A computer implemented method for creating and displaying a transient buddy list, wherein the buddy list comprises indicators of a current status of each element within the buddy list, the method comprising steps of:
browsing through groupings of items, each item associated with an interval of time and referencing a person or persons;
searching for at least one match to a person or persons referenced in an item grouping by accessing information stored in a repository accessible to a user of the buddy list;
mapping the person or persons referenced in the item grouping to the person or persons referenced in the stored information within the repository accessible to the user for accessing an at least one instant message identifier of the person or persons;
creating the buddy list, populated by the at least one instant message identifier derived from the mapping step;
sorting the buddy list according to time intervals; and
displaying the buddy list.

2. The computer-implemented method of claim 1 wherein the instant message identifier is retrieved from an instant message system.

3. The computer-implemented method of claim 2 wherein if an instant message identifier is retrieved from an instant message system to which the user is not subscribed, the instant message identifier is displayed with a second indicator different from the first indicator.

4. The computer-implemented method of claim 1 wherein the sorting step further comprises sorting the buddy list alphabetically within time intervals.

5. The computer-implemented method of claim 1 further comprising a step of: dynamically updating the buddy list, based upon a change to an item grouping.

6. The computer-implemented method of claim 1 wherein the displaying step further comprises:
displaying the created buddy list around a clock face.

7. The computer-implemented method of claim 1 further comprising a step of: storing the buddy list associated with a time period for future reference.

8. The computer-implemented method of claim 1 wherein the steps of browsing, searching, mapping, creating and sorting are automatically executed at periodic intervals to keep the transient buddy list up to date and accurate.

9. An interface for creating and displaying a transient buddy list, the interface comprising:
a time interval digital display mechanism that displays time;
at least one of a group consisting of: a time selection tool, a date selection tool, and a timeline selection tool for selecting a range between two dates; and
a display screen for displaying the buddy list.

10. The interface of claim 9 wherein the time interval digital display mechanism is a clock face.

11. The interface of claim 9 wherein the display screen is configured for alternately displaying the time and the buddy list, based upon user selection, such that when the time is displayed, the buddy list is not viewable, and when the buddy list is displayed, the time is not viewable.

12. The interface of claim 11 wherein the time and the buddy list can be simultaneously displayed on the display screen, where, based upon user selection, one of either the time or the buddy list is displayed in the foreground of the display screen.

13. The interface of claim 10 wherein hovering over a time interval on the clock face calls up a buddy list for that time interval and wherein hovering is accomplished by moving a stylus or cursor over the area without depressing the stylus or clicking on a mouse.

12. The interface of claim 10 wherein a region in the center of the clock face is associated with the buddy list for a current time interval such that selecting said region displays the buddy list for the current time interval.

13. The interface of claim 10 wherein the region in the center of the clock face is associated with the buddy list for a current date such that selecting said region displays the buddy list for the current date.

14. The interface of claim 10 wherein morning and afternoon hours are represented by different identifiers.

15. The interface of claim 10 wherein the identifiers are icons representing morning and afternoon hours and the icons are displayed around the clock face.

16. The interface of claim 9 further comprising a synchronization tool for synchronizing the buddy list with a user's mobile device, wherein the synchronization tool can be utilized to transmit information between the buddy list and the user's mobile device, the information comprising identifiers and contact information.

17. The interface of claim 10 wherein at least one indicator associated with a buddy list is displayed around the clock face, the at least one indicator referencing, by its position on the clock face, the time interval associated with the buddy list.

18. The interface of claim 16 wherein the information from the user's mobile device is transmitted in response to calls made from the user's mobile device.

19. A system for creating and displaying a transient buddy list comprising indicators of a current status of each element within the buddy list, the system comprising:
a processor configured with logic for:
browsing through groupings of items, each item associated with an interval of time and referencing a person or persons;
searching for at least one match to a person or persons referenced in an item grouping by accessing information stored in a repository accessible to a user of the buddy list;
mapping the person or persons referenced in the item grouping to the person or persons referenced in the stored information within the repository accessible to the user for accessing an at least one instant message identifier of the person or persons;
creating the buddy list, populated by the at least one instant message identifier derived from the mapping step;
sorting the buddy list according to time intervals; and
displaying the buddy list.

20. The system of claim 19 wherein the processor further comprises logic for storing, for future reference, the buddy list associated with a given time period.
